(19) United States
(12) Patent Application Publication
(10) Pub. No.: US 2026/0131631 A1
(43) Pub. Date: May 14, 2026

(54) THERMAL MANAGEMENT SYSTEM FOR A VEHICLE

(71) Applicants: HYUNDAI MOTOR COMPANY, Seoul (KR); KIA CORPORATION, Seoul (KR)

(72) Inventors: Jian Xiong Zhao, Yantai (CN); Xinyu Cui, Yantai (CN); Won Young Jeong, Hwaseong-si (KR); Cai Wu, Yantai (CN)

(73) Assignees: HYUNDAI MOTOR COMPANY, Seoul (KR); KIA CORPORATION, Seoul (KR)

(21) Appl. No.: 19/383,154

(22) Filed: Nov. 7, 2025

(30) Foreign Application Priority Data
Nov. 8, 2024 (CN) 202411590273.6

(51) Int. Cl. B60H 1/00

(52) U.S. Cl. CPC B60H 1/00899; B60H 1/00278

(57) ABSTRACT

A thermal management system for a vehicle includes a first coolant circulation circuit including a first pump, a first electrical component, a second pump, and a second electrical component connected through a first coolant line. The system includes a first coolant connection line including a first end and a second end. The first end is connected to the first coolant line upstream of the first pump and the first electrical component and downstream of the second pump and the second electrical component. The second end is connected to the first coolant line downstream of the first pump and the first electrical component and upstream of the second pump and the second electrical component. The system includes an HVAC module and a heat exchanger disposed on the first coolant connection line. The heat exchanger is located inside the HVAC module to heat air introduced into the HVAC module using a coolant.

### CROSS-REFERENCE TO RELATED APPLICATION

This application claims, under 35 U.S.C. § 119(a), priority to and the benefit of Chinese Patent Application No. 202411590273.6, filed at the Chinese National Intellectual Property Administration on Nov. 8, 2024, the entire contents of which are incorporated herein by reference.

### BACKGROUND

### Technical Field

The present disclosure relates to a thermal management system for a vehicle, and more particularly, to a thermal management system for a vehicle, which heats a vehicle interior and a battery.

### Description of the Related Art

A battery, which is a power source of an electric vehicle, may lose electricity (i.e., charge) rapidly in low-temperature environments, thus reducing driving range of the electric vehicle. Users of electric vehicles are likely to feel anxiety about the driving range, especially in winter, and due to this, the use of electric vehicles may be limited. One reason for the rapid loss of electricity (i.e., charge) of the battery in low-temperature environments is the high power consumption of the heater used to heat the vehicle interior and the battery.

To solve the problem of high power consumption of the heater, heat pump systems have already been developed, but the structure of these heat pump systems are complex and their cost is relatively high. In addition, since the heat pump system is used only for heating the vehicle interior, it cannot solve the problem of power consumption of the heater for heating the battery. Therefore, heat pump systems are not suitable for all electric vehicles, and it is difficult to completely solve the problem of high power consumption of the heater.

The above information in this Background section is only for enhancement of understanding of the background of the disclosure. Therefore, the Background section may contain information that does not form the prior art that is already known to a person of ordinary skill in the art.

### SUMMARY

The present disclosure provides a thermal management system for a vehicle that heats a vehicle interior and a battery using waste heat of an electrical component in the vehicle.

Technical problems to be solved by the present disclosure are not limited to the above-mentioned problems, and other technical problems, which are not mentioned above, should be clearly understood from the following descriptions by those having ordinary skill in the art to which the present disclosure pertains.

In order to achieve the objectives described above, the present disclosure provides a thermal management system for a vehicle. The thermal management system for the vehicle may include: a coolant configured to flow throughout the thermal management system and a first coolant circulation circuit including a first pump, a first electrical component, a second pump, and a second electrical component that are connected through a first coolant line. The system may further include a first coolant connection line including a first end and a second end. The first end of the first coolant connection line may be connected to the first coolant line at a position upstream of the first pump and the first electrical component and downstream of the second pump and the second electrical component. The second end of the first coolant connection line may be connected to the first coolant line at a position downstream of the first pump and the first electrical component and upstream of the second pump and the second electrical component. The system may also include an HVAC module of an air conditioning device disposed on the first coolant connection line. The system may further include a heat exchanger disposed on the first coolant connection line and located inside the HVAC module to heat air introduced into the HVAC module using the coolant whose temperature has risen while passing through one or more of the first electrical component and the second electrical component.

The thermal management system may further include a second coolant connection line including a first end and a second end. The first end of the second coolant connection line may be connected to the first coolant line at a position downstream of the first electrical component. The second end of the second coolant connection line may be connected to the first coolant line at a position upstream of the second electrical component. The system may also include a first radiator disposed on the second coolant connection line to cool the coolant whose temperature has risen while passing through the first electrical component and the second electrical component.

The thermal management system may further include a second coolant circulation circuit including a battery and a third pump connected through a second coolant line. The system may also include a coolant mixing tank disposed on the first coolant line and the second coolant line to mix the coolant in the first coolant line and the coolant in the second coolant line.

The thermal management system may further include a third coolant connection line including a first end and a second end. The first end of the third coolant connection line may be connected to the second coolant line at a position upstream of the battery. The second end of the third coolant connection line may be connected to the second coolant line at a position downstream of the battery. The system may also include a second radiator disposed on the third coolant connection line to cool the coolant whose temperature has risen while passing through the battery.

The thermal management system may further include: a first valve configured as a switch valve and disposed on the first coolant line downstream of the first electrical component, and a second valve configured as a three-way valve and disposed on the first coolant line upstream of the second electrical component. The second valve may include a plurality of ports, where the plurality of ports may include a first port, a second port, and a third port. The system may also include a third valve configured as a three-way valve and disposed on the second coolant line. The third valve may include a plurality of ports, where the plurality of ports may include a first port, a second port, and a third port. The second end of the second coolant connection line may be selectively connected to the first coolant line through the second valve, and the first end of the third coolant connection line may be selectively connected to the second coolant line through the third valve. The first port of the second valve may be connected to the second coolant connection line, the second port of the second valve may be connected to the first coolant line upstream of the second electrical component, and the third port of the second valve may be connected to the first coolant line downstream of the coolant mixing tank. The first port of the third valve may be connected to the third coolant connection line, the second port of the third valve may be connected to the second coolant line upstream of the battery, and the third port of the third valve may be connected to the second coolant line downstream of the coolant mixing tank.

The thermal management system may further include a controller electrically connected to the first valve, the second valve, the third valve, the first pump, the second pump, and the third pump. The controller may be configured to determine a mode of the thermal management system according to one or more of a temperature of the first electrical component, a temperature of the second electrical component, and a temperature of the battery. The controller may be further configured to control operation of the first valve, the second valve, and the third valve and operation of the first pump, the second pump, and the third pump according to the mode.

When a vehicle interior needs to be heated and the battery does not need to be heated in a vehicle driving state, the controller may be configured to determine the mode of the thermal management system as a first heating mode, a second heating mode, or a third heating mode according to the temperature of the first electrical component and the temperature of the second electrical component.

In the first heating mode, the controller may open the first valve, close the plurality of ports of the second valve and the plurality of ports of the third valve, and operate the first pump. The coolant whose temperature has risen while passing through the first electrical component may flow into the heat exchanger through the first coolant connection line to heat the air introduced into the HVAC module.

In the second heating mode, the controller may open the first valve, close the first port of the second valve, open the second port of the second valve and the third port of the second valve, close the plurality of ports of the third valve, and operate the first pump and the second pump. The coolant whose temperature has risen while passing through the first electrical component and the second electrical component may flow into the heat exchanger through the first coolant connection line to heat the air introduced into the HVAC module and pass through the coolant mixing tank through the first coolant line to flow back into the second electrical component.

In the third heating mode, the controller may close the first valve, open the plurality of ports of the second valve, close the plurality of ports of the third valve, and operate the first pump and the second pump. A portion of the coolant whose temperature has risen while passing through the second electrical component may flow into the heat exchanger through the first coolant connection line to heat the air introduced into the HVAC module. The remainder of the coolant whose temperature has risen while passing through the second electrical component and the coolant whose temperature has risen while passing through the first electrical component and may flow into the first radiator disposed on the second coolant connection line connected through the second valve and be cooled. The coolant cooled by the first radiator may flow back into the second electrical component through the first coolant line to cool the one or more of the first electrical component and the second electrical component.

When the vehicle interior and the battery need to be heated in a vehicle driving state, the controller may be configured to determine the mode of the thermal management system as a fourth heating mode, a fifth heating mode, or a sixth heating mode according to the temperature of the first electrical component, the temperature of the second electrical component, and the temperature of the battery.

In the fourth heating mode, the controller may open the first valve, close the first port of the second valve, open the second port of the second valve and the third port of the second valve, close the first port of the third valve, open the second port of the third valve and the third port of the third valve, and operate the first pump, the second pump, and the third pump. A portion of the coolant whose temperature has risen while passing through the first electrical component and the second electrical component may flow into the heat exchanger through the first coolant connection line to heat the air introduced into the HVAC module. A remainder of the coolant whose temperature has risen while passing through the first electrical component and the second electrical component may flow into the coolant mixing tank through the first coolant line and be mixed with the coolant whose temperature has risen while passing through the battery that has flowed into the coolant mixing tank through the second coolant line. The remainder of the coolant whose temperature has risen while passing the first electrical component and the second electrical component may raise the temperature of the coolant circulating in the second coolant line to heat the battery.

In the fifth heating mode, the controller may open the first valve, close the first port of the second valve, open the second port of the second valve and the third port of the second valve, open the plurality of ports of the third valve, and operate the first pump, the second pump, and the third pump. A portion of the coolant whose temperature has risen while passing through the first electrical component and the second electrical component may flow into the heat exchanger through the first coolant connection line to heat the air introduced into the HVAC module. A remainder of the coolant whose temperature has risen while passing through the first electrical component and the second electrical component may flow into the coolant mixing tank through the first coolant line. A portion of the coolant whose temperature has risen while passing through the battery may flow into the coolant mixing tank through the second coolant line. The coolant in the first coolant line and the coolant in the second coolant line may be mixed in the coolant mixing tank to raise the temperature of the coolant in the second coolant line. A remainder of the coolant whose temperature has risen while passing through the battery may flow into the second radiator through the third coolant connection line connected through the third valve and be cooled. The coolant cooled in the second radiator may lower the temperature of the coolant in the second coolant line to maintain the temperature of the battery.

In the sixth heating mode, the controller may close the first valve, open the plurality of ports of the second valve, close the first port of the third valve, open the second port of the third valve and the third port of the third valve, and operate the first pump, the second pump, and the third pump. A portion of the coolant whose temperature has risen while passing through the second electrical component may flow into the heat exchanger through the first coolant connection line to heat the air introduced into the HVAC module. The portion of the coolant whose temperature has risen while passing through the second electrical component that has passed through the heat exchanger may flow into the coolant mixing tank through the first coolant line. The coolant whose temperature has risen while passing through the battery may flow into the coolant mixing tank through the second coolant line. The coolant in the first coolant line and the coolant in the second coolant line may be mixed in the coolant mixing tank to raise the temperature of the coolant in the second coolant line, and the coolant in the second coolant line whose temperature has risen may heat the battery. A remainder of the coolant whose temperature has risen while passing through the second electrical component and the coolant whose temperature has risen while passing through the first electrical component may flow into the first radiator through the second coolant connection line connected through the second valve and be cooled. The coolant cooled by the first radiator may flow back into the second electrical component through the first coolant line to cool the one or more of the first electrical component and the second electrical component.

When the vehicle interior needs to be heated and the battery does not need to be heated in a battery charging state, the controller may be configured to determine the mode of the thermal management system for the vehicle as a seventh heating mode or an eighth heating mode according to the temperature of the second electrical component.

In the seventh heating mode, the controller closes the first valve, closes the first port of the second valve, opens the second port of the second valve and the third port of the second valve, closes the plurality of ports of the third valve, and operates the second pump. The coolant whose temperature has risen while passing through the second electrical component may flow into the heat exchanger through the first coolant connection line to heat the air introduced into the HVAC module.

In the eighth heating mode, the controller may close the first valve, open the plurality of ports of the second valve, close the plurality of ports of the third valve, and operate the first pump and the second pump. A portion of the coolant whose temperature has risen while passing through the second electrical component may flow into the heat exchanger through the first coolant connection line to heat the air introduced into the HVAC module. A remainder of the coolant whose temperature has risen while passing through the second electrical component may flow into the first radiator through the second coolant connection line connected through the second valve and be cooled. The coolant cooled by the first radiator may flow back into the second electrical component to cool the second electrical component.

The controller may be configured to determine the mode of the thermal management system for the vehicle as a ninth heating mode, when the vehicle interior and the battery need to be heated in a battery charging state.

In the ninth heating mode, the controller may close the first valve, close the first port of the second valve, open the second port of the second valve and the third port of the second valve, close the first port of the third valve, open the second port of the third valve and the third port of the third valve, and operate the second pump and the third pump. The coolant whose temperature has risen while passing through the second electrical component may flow into the heat exchanger through the first coolant connection line to heat the air introduced into the HVAC module. The coolant whose temperature has risen while passing through the second electrical component that has passed through the heat exchanger flows into the coolant mixing tank through the first coolant line. The coolant whose temperature has risen while passing through the battery may flow into the coolant mixing tank through the second coolant line. The coolant in the first coolant line and the coolant in the second coolant line may be mixed in the coolant mixing tank to raise the temperature of the coolant in the second coolant line. The coolant in the second coolant line, whose temperature has risen, may heat the battery.

When the vehicle interior needs to be heated and the temperature of the battery needs to be maintained in a battery charging state, the controller may be configured to determine the mode of the thermal management system for the vehicle as a tenth heating mode.

in the tenth heating mode, the controller may close the first valve, may close the first port of the second valve, may open the second port of the second valve and the third port of the second valve, may open the plurality of ports of the third valve, and may operate the second pump and the third pump. The coolant whose temperature has risen while passing through the second electrical component may flow into the heat exchanger to heat the air introduced into the HVAC module. The coolant whose temperature has risen while passing through the second electrical component that has passed through the heat exchanger may flow into the coolant mixing tank through the first coolant line. A portion of the coolant whose temperature has risen while passing through the battery may flow into the coolant mixing tank through the second coolant line. The coolant in the first coolant line and the coolant in the second coolant line may be mixed in the coolant mixing tank to raise the temperature of the coolant in the second coolant line. A remainder of the coolant whose temperature has risen while passing through the battery may flow into the second radiator through the third coolant connection line connected through the third valve and be cooled. The coolant cooled in the second radiator may lower the temperature of the coolant in the second coolant line to maintain the temperature of the battery.

When one or more of cooling of the first electrical component and the second electrical component and cooling of the battery is required in a vehicle driving state, the controller may be configured to determine the mode of the thermal management system for the vehicle as a cooling mode.

In the cooling mode used for the first electrical component and the second electrical component, the controller may close the third port of the second valve, open the first port of the second valve and the second port of the second valve, close the first valve, and operate the first pump and the second pump. The coolant whose temperature has risen while passing through the first electrical component and the second electrical component may flow into the first radiator on the second coolant connection line connected through the second valve and be cooled. The coolant cooled by the first radiator may flow back into the second electrical component to cool the one or more of the first electrical component and the second electrical component. In the cooling mode used for the battery, the controller may close the third port of the third valve, open the first port of the third valve and the second port of the third valve, and operate the third pump. The coolant whose temperature has risen while passing through the battery may flow into the second radiator through the third coolant connection line connected through the third valve and be cooled. The coolant cooled by the second radiator may flow into the second coolant line to cool the battery.

The thermal management system for a vehicle according to an embodiment of the present disclosure may heat the interior of the vehicle and the battery with waste heat generated from electrical components in the vehicle using a heat exchanger and a coolant mixing tank. Compared to a heat pump system, the thermal management system for a vehicle according to an embodiment of the present disclosure has a simple structure and low cost, and may reduce the power consumption of the heater, thereby improving the driving range of an electric vehicle.

The above and other features of the disclosure are discussed below. The effects obtained by the present disclosure are not limited to the aforementioned effects, and other effects, which are not mentioned above, should be clearly understood by those having ordinary skill in the art from the following description.

### BRIEF DESCRIPTION OF THE DRAWINGS

The above and other aspects, features, and other advantages of the present disclosure should be more clearly understood from the following description taken in conjunction with the accompanying drawings, in which:

FIG. 1 is a schematic diagram showing a thermal management system for a vehicle according to an embodiment of the present disclosure.

FIG. 2 is a block diagram of the thermal management system of the vehicle according to an embodiment of the present disclosure.

FIG. 3 is a schematic diagram illustrating a first heating mode of the thermal management system of the vehicle according to an embodiment of the present disclosure.

FIG. 4 is a schematic diagram illustrating a second heating mode of the thermal management system of the vehicle according to an embodiment of the present disclosure.

FIG. 5 is a schematic diagram illustrating a third heating mode of the thermal management system of the vehicle according to an embodiment of the present disclosure.

FIG. 6 is a schematic diagram illustrating a fourth heating mode of the thermal management system of the vehicle according to an embodiment of the present disclosure.

FIG. 7 is a schematic diagram illustrating a fifth heating mode of the thermal management system of the vehicle according to an embodiment of the present disclosure.

FIG. 8 is a schematic diagram illustrating a sixth heating mode of the thermal management system of the vehicle according to an embodiment of the present disclosure.

FIG. 9 is a schematic diagram illustrating a seventh heating mode of the thermal management system of the vehicle according to an embodiment of the present disclosure.

FIG. 10 is a schematic diagram illustrating an eighth heating mode of the thermal management system of the vehicle according to an embodiment of the present disclosure.

FIG. 11 is a schematic diagram illustrating a ninth heating mode of the thermal management system of the vehicle according to an embodiment of the present disclosure.

FIG. 12 is a schematic diagram illustrating a tenth heating mode of the thermal management system of the vehicle according to an embodiment of the present disclosure.

FIG. 13 is a schematic diagram of a cooling mode of the thermal management system of the vehicle according to an embodiment of the present disclosure.

It should be understood that the appended drawings are not drawn to scale, presenting a somewhat simplified representation of various features illustrative of the basic principles of the disclosure. The specific design features of the present disclosure as disclosed herein, including, for example, specific dimensions, orientations, locations, and shapes, should be determined in part by the particular intended application and use environment.

In the figures, reference numbers refer to the same or equivalent parts of the present disclosure throughout the several figures of the drawings.

### DETAILED DESCRIPTION

The specific structural and functional descriptions of embodiments of the

present disclosure or application disclosed herein are merely illustrative for the purpose of describing disclosed embodiments. The disclosed embodiments may be implemented in various forms and should not be construed as being limited to the embodiments described in the present disclosure or application.

The disclosed embodiments may be subject to various modifications and take on various forms. Therefore, specific embodiments are illustrated in the drawings and described in detail in the present disclosure or application. However, this is not intended to limit the embodiments according to the concept of the disclosed embodiments to the specific forms disclosed. It should be understood to include all changes, equivalents, and substitutes encompassed within the spirit and scope of the present disclosure.

Unless otherwise defined, all terms used herein, including technical and scientific terms, have the same meaning as commonly understood by those having ordinary skill in the art to which the present disclosure pertains. Terms generally defined in commonly used dictionaries should be interpreted as having meanings consistent with the context of the relevant technology and should not be construed in an idealized or overly formal sense unless explicitly defined herein.

In describing embodiments disclosed in the present disclosure, when a detailed description of the related art is determined to obscure the gist of the embodiments disclosed in the present disclosure, the detailed description thereof has been omitted herein. In addition, the accompanying drawings are merely for easy understanding of the embodiments disclosed in the present disclosure, and the technical ideas disclosed in the present disclosure are not limited by the accompanying drawings, and should be understood to include all changes, equivalents, and substitutes included in the spirit and technical scope of the present disclosure.

Terms including ordinal numbers such as “first”, “second”, and the like used herein may be used to describe various components, but the components are not limited by these terms. The terms are used only for the purpose of distinguishing one component from another component.

As used herein, the term “vehicle,” “vehicular,” or other similar terms generally include a motor vehicle, such as a passenger vehicle including a sport utility vehicle (SUV), a bus, a truck, various commercial vehicles, watercraft including various boats and ships, aircraft, and the like. It should also be understood to include a hybrid vehicle, an electric vehicle, a plug-in hybrid electric vehicle, a hydrogen-powered vehicle, and other alternative fuel (fuel derived from resources other than petroleum) vehicles.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof. In addition, a “unit” included in the names of an internal configuration of the present disclosure, such as a power distribution unit (PDU), generally refer to a controller that controls the specific function of a vehicle and do not mean a generic function unit.

Although an embodiment is described as performing a process using a plurality of units, it should be understood that the process may also be performed by one or a plurality of modules. Furthermore, it should be understood that the term “controller” refers to a hardware device including a memory and a processor. The memory is configured to store a module, and the processor is specifically configured to execute the module to complete one or a plurality of processes described further below.

The terminology used herein is for the purpose of describing particular embodiments only and is not intended to be limiting of the present invention. As used herein, the singular forms “a,” “an,” and “the above” are intended to include the plural forms as well, unless the context clearly indicates otherwise. Further, as used in this specification, the term “comprising” specifies the presence of the stated feature, integer, step, operation, element, and/or component, but does not preclude the presence or addition of one or more other feature, integer, step, operation, element, component, and/or a combination thereof. As used herein, the term “and/or” includes any and all combinations of one or more of the associated listed items.

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

Any number or variety of components in any of the configurations described herein can be included in the present disclosure, as described herein. The components can include any combination of the features described herein, and can be arranged in any of the various configurations described herein. The structure and arrangement of components of the present disclosure, as well as the concepts regarding their use can apply not only to the specific examples discussed herein, but to any number of embodiments in any combination. Various examples of the present disclosure including some having various features in various arrangements are described below with reference to the drawings.

Hereinafter, various embodiments disclosed of the present disclosure are described in detail with reference to the accompanying drawings. The same reference numerals are given to the same or similar components regardless of reference numerals, and a repetitive description thereof are omitted.

Referring now to the drawings, a thermal management system for a vehicle according to an embodiment is described.

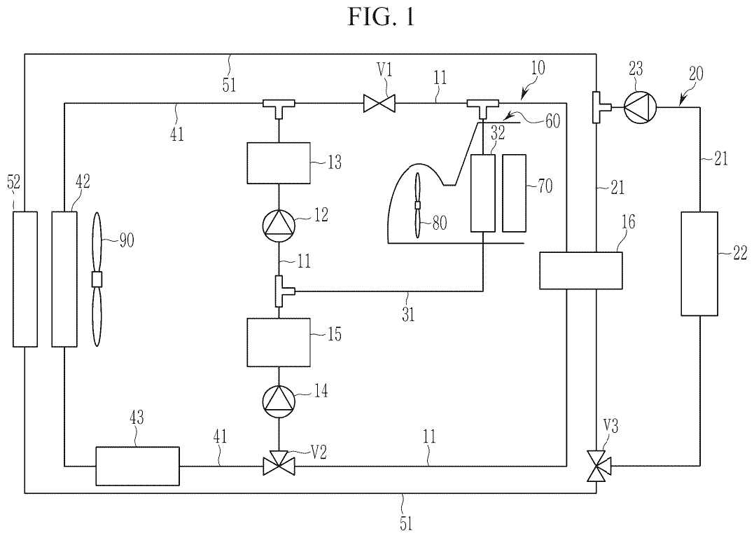

FIG. 1 is a schematic diagram showing a thermal management system for a vehicle according to an embodiment of the present disclosure.

As shown in FIG. 1, a thermal management system of the vehicle may include a first coolant circulation circuit 10 and a second coolant circulation circuit 20.

The first coolant circulation circuit 10 may include a first pump 12, a first electrical component 13, a second pump 14, and a second electrical component 15, which are connected through a first coolant line 11.

In an embodiment, the first electrical component 13 may include a motor, which is a power source of an electric vehicle, and a motor controller (MCU). The second electrical component 15 may include a power distribution unit (PDU), an on-board charger (OBC), and a low-voltage DC/DC converter (LDC). However, the present disclosure is not limited thereto, and the first electrical component 13 and the second electrical component 15 may be electrical components that consume power in the electric vehicle.

The second coolant circulation circuit 20 may include a battery 22 and a third pump 23, which are connected through a second coolant line 21.

In an embodiment, the battery 22 may be a battery that is a power source of the electric vehicle.

The thermal management system of the vehicle may further include a coolant mixing tank 16 installed in the first coolant line 11 and the second coolant line 21. The coolant mixing tank 16 may be configured to sufficiently mix a coolant flowing into the coolant mixing tank 16 through the first coolant line 11 and a coolant flowing into the coolant mixing tank 16 through the second coolant line 21 into the coolant mixing tank 16. Therefore, a temperature of the coolant in the first coolant line 11 passed through the coolant mixing tank 16 and a temperature of the coolant in the second coolant line 21 passed through the coolant mixing tank 16 are the same.

The thermal management system of the vehicle may further include a first coolant connection line 31 and a heat exchanger 32.

A first end of the first coolant connection line 31 may be connected to the first coolant line 11 at a position upstream of the first pump 12 and the first electrical component 13 and downstream of the second pump 14 and the second electrical component 15. A second end of the first coolant connection line 31 may be connected to the first coolant line 11 at a position downstream of the first pump 12 and the first electrical component 13, and upstream of the second pump 14 and the second electrical component 15.

The heat exchanger 32 may be installed in the first coolant connection line 31 and disposed inside a heating ventilation and air conditioning (HVAC) module 60 of an air conditioner. The heat exchanger 32 may be a heat exchanger that promotes heat-exchange between air and coolant. The coolant (i.e., whose temperature is increased while passing through the first electrical component 13 and/or the second electrical component 15) may flow into the heat exchanger 32 and thus may exchange heat with air flowing into the HVAC module 60 in the heat exchanger 32. Thus, the waste heat of the first electrical component 13 and/or the second electrical component 15 (i.e., one or more of the first electrical component 13 and the second electrical component 15) may be used to heat the air flowing into the HVAC module 60.

A heater 70 may be installed at a rear side of the heat exchanger 32 in the HVAC module 60. When the temperature of the air heated through the heat exchanger 32 does not reach a target temperature, the heater 70 may be operated to additionally heat the air. In addition, a fan 80 may be installed in front of the heat exchanger 32 inside the HVAC module 60 to introduce air from outside of the vehicle to inside of the vehicle. Here, the front-rear direction means the front-rear direction of the vehicle.

The thermal management system of the vehicle may further include a second coolant connection line 41, a first radiator 42, and a liquid storage tank 43.

A first end of the second coolant connection line 41 may be connected to the first coolant line 11 downstream of the first electrical component 13, and a second end of the second coolant connection line 41 may be connected to the first coolant line 11 upstream of the second electrical component 15.

The first radiator 42 may be installed in the second coolant connection line 41. The coolant (i.e., whose temperature has risen when passing through the first electrical component 13 and/or the second electrical component 15, or whose temperature has risen while passing through one or more of the first electrical component 13 and the second electrical component 15) may flow into the first radiator 42 through the second coolant connection line 41 and exchange heat with external air at the first radiator 42. Therefore, the first electrical component 13 and the second electrical component 15 may be cooled through the first radiator 42.

The liquid storage tank 43 may be installed in the second coolant connection line 41 to store the coolant.

The thermal management system of the vehicle may further include a third coolant connection line 51 and a second radiator 52.

Both ends of the third coolant connection line 51 (i.e., a first end of the third coolant connection line 51 and a second end of the third coolant connection line 51) may be connected to the second coolant line 21 upstream of the battery 22 and the second coolant line 21 downstream of the battery 22, respectively. In other words, a first end of the third coolant connection line 51 may be connected to the second coolant line upstream of the battery, and a second end of the third coolant connection line 51 may be connected to the second coolant line downstream of the battery.

The second radiator 52 may be installed in the third coolant connection line 51. The coolant (i.e., whose temperature has risen when passing through the battery 22) may flow into the second radiator 52 through the third coolant connection line 51 and exchange heat with external air at the second radiator 52. Therefore, the battery 22 may be cooled through the second radiator 52.

A cooling fan 90 may be installed at a rear side of the first radiator 42 and the second radiator 52 to cool the coolant in the first radiator 42 and the second radiator 52.

The thermal management system of the vehicle may further include a first valve V1, a second valve V2, and a third valve V3.

The first valve V1 may be a switch valve. The first valve V1 may be installed in the first coolant line 11 downstream of the first electrical component 13.

Specifically, when the first valve V1 is opened, the first coolant line 11 downstream of the first electrical component 13 may be connected with the first coolant connection line 31 such that the coolant flowing through the first electrical component 13 may flow into the heat exchanger 32 through the first coolant connection line 31. When the first valve V1 is closed, the connection of the first coolant line 11 downstream of the first electrical component 13 with the first coolant connection line 31 may be blocked such that the coolant flowing through the first electrical component 13 does not flow into the heat exchanger 32 through the first coolant connection line 31, but the coolant flowing through the second electrical component 15 may flow into the heat exchanger through the first coolant connection line 31.

The second valve V2 may be a three-way valve. The second valve V2 may be installed in the first coolant line 11 upstream of the second electrical component 15, and the second end of the second coolant connection line 41 may be connected to the first coolant line 11 upstream of the second electrical component 15 through the second valve V2. A first port of the second valve V2 may be connected to the second coolant connection line 41, a second port of the second valve V2 may be connected to the first coolant line 11 upstream of the second electrical component 15, and a third port of the second valve V2 may be connected to the first coolant line 11 downstream of the coolant mixing tank 16.

Specifically, when the first port and the second port of the second valve V2 are opened, the first coolant line 11 communicates with the second coolant connection line 41 and a coolant (i.e., whose temperature has risen when flowing through the first electrical component 13 and/or the second electrical component 15, or whose temperature has risen when flowing through the one or more of the first electrical component 13 and the second electrical component 15) may flow into the second coolant connection line 41 connected through the second valve V2. Accordingly, the first electrical component 13 and the second electrical component 15 may be cooled through the first radiator 42 on the second coolant connection line 41.

When the first port of the second valve V2 is closed, the connection of the first coolant line 11 with the second coolant connection line 41 may be blocked, and thus the coolant flowing past the first electrical component 13 and the second electrical component 15 may not flow into the first radiator 42 through the second coolant connection line 41.

The third valve V3 may be a three-way valve. The third valve V3 may be installed on the second coolant line 21, and a first end of the third coolant connection line 51 may be connected to the second coolant line 21 through the third valve V3. A first port of the third valve V3 may be connected to the third coolant connection line 51, a second port of the third valve V3 may be connected to the second coolant line 21 upstream of the battery 22, and a third port of the third valve V3 may be connected to the second coolant line 21 downstream of the coolant mixing tank 16.

Specifically, when the first port and the second port of the third valve V3 are opened, the second coolant line 21 may communicate with the third coolant connection line 51, and thus the coolant (i.e., whose temperature has risen when flowing past the battery 22) may flow into the third coolant connection line 51 through the third valve V3. Accordingly, the battery 22 may be cooled through the second radiator 52 on the third coolant connection line 51.

When the first port of the third valve V3 is closed, the connection of the second coolant line 21 with the third coolant connection line 51 may be blocked, and thus the coolant flowing past the battery 22 (i.e., whose temperature has risen passing through the battery 22) does not flow into the second radiator 52 through the third coolant connection line 51.

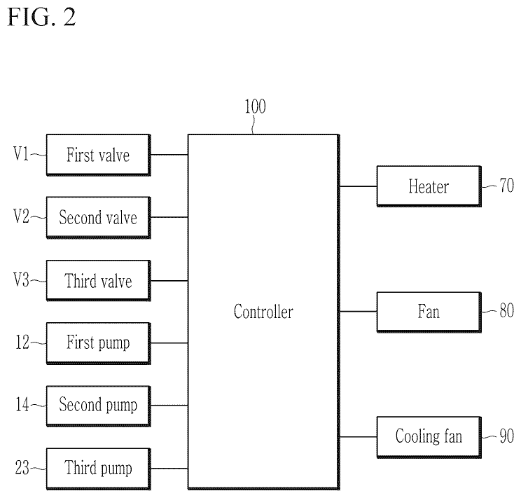

FIG. 2 is a block diagram of the thermal management system of the vehicle according to the embodiment of the present disclosure.

As shown in FIG. 2, the thermal management system of the vehicle may further include a controller 100. The controller 100 may be electrically connected to the first valve V1, the second valve V2, the third valve V3, the first pump 12, the second pump 14, and the third pump 23. In addition, the controller 100 may be electrically connected to the heater 70, the fan 80, and the cooling fan 90. The controller 100 may be a stand-alone controller, or the controller 100 may be integrated with a controller of an air conditioning device or a battery thermal management device (not shown). The electrical connection may include a connection through a wired network or a wireless network. For example, the electrical connection may mean a connection through controller area network (CAN).

In addition, the thermal management system of the vehicle may further include various sensors (not shown) such as a temperature sensor for sensing temperature.

The controller 100 may be configured to determine a mode of the thermal management system of the vehicle according to at least one (i.e., one or more) of a temperature of the first electrical component 13, a temperature of the second electrical component 15, and a temperature of the battery 22. According to the determined mode, the controller 100 may control the operation of the first valve V1, the second valve V2, and the third valve V3 and the operation of the first pump 12, the second pump 14, and the third pump 23. In addition, the controller 100 may control the operation of the heater 70, the fan 80, and the cooling fan 90. Here, the operation of the first valve V1 means the opening and closing of the first valve V1, and the operation of the second valve V2 and the third valve V3 means the opening, closing, and flow rate of each port of the second valve V2 and the third valve V3.

In an embodiment, the thermal management system of the vehicle may include a heating mode and a cooling mode. The heating mode may include a first heating mode to a tenth heating mode.

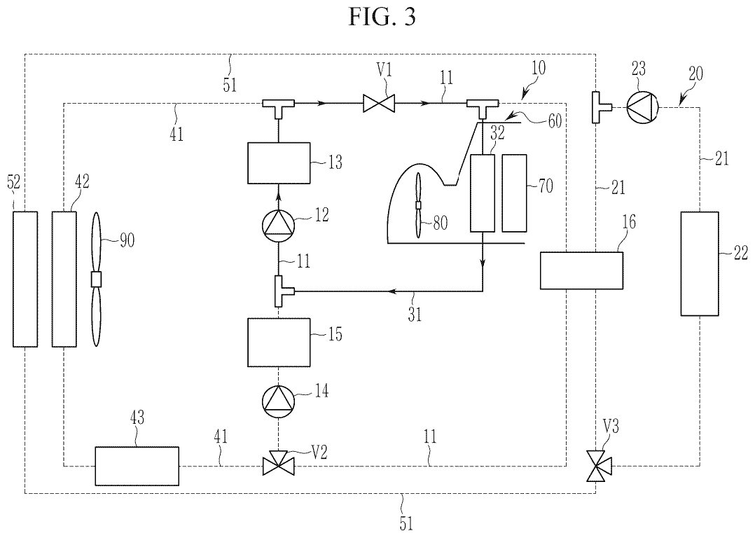

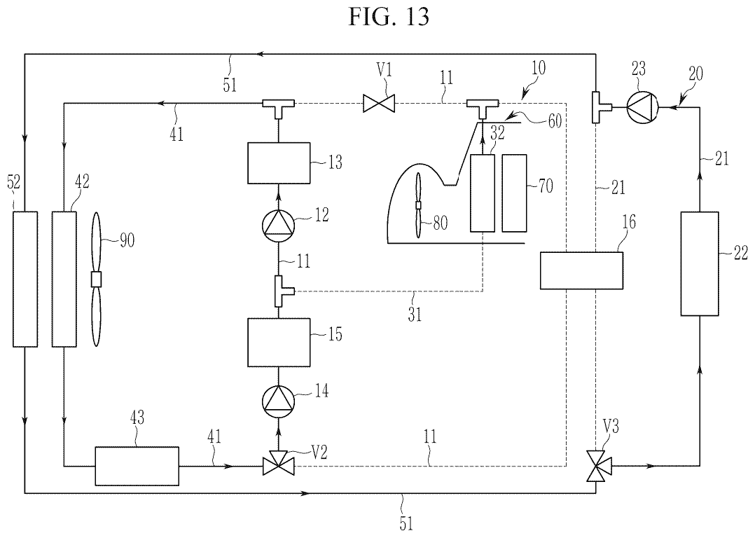

FIG. 3 to FIG. 12 are schematic diagrams illustrating a first heating mode to a tenth heating mode of the thermal management system of the vehicle, respectively, and FIG. 13 is a schematic diagram of a cooling mode of the thermal management system of the vehicle according to an embodiment.

Hereinafter, referring to FIG. 3 to FIG. 13, each mode of the thermal management system of the vehicle according to an embodiment of the present disclosure is described in detail.

When the vehicle travels in a low-temperature environment, heating of the interior of the vehicle and/or heating of the battery 22 may be necessary. Heat may be generated from the first electrical component 13 and the second electrical component 15 during vehicle operation, and the interior of the vehicle and the battery 22 may be heated using waste heat generated from the first electrical component 13 and/or the second electrical component 15 (i.e., one or more of the first electrical component 13 and the second electrical component 15).

FIG. 3 to FIG. 5 illustrate a first heating mode to a third heating mode of the thermal management system of the vehicle. Specifically, when the vehicle travels in a low-temperature environment, if the interior of the vehicle needs to be heated but the battery 22 does not need to be heated, the controller 100 may determine the mode of the thermal management system of the vehicle as one of the first heating mode, the second heating mode, and the third heating mode (i.e., the first heating mode, the second heating mode, or the third heating mode). The controller 100 may determine the mode according to a temperature of the first electrical component 13 and a temperature of the second electrical component 15.

In an embodiment, when the temperature of the first electrical component 13 is higher than the temperature of the second electrical component 15, the controller 100 may determine the mode of the thermal management system of the vehicle as the first heating mode to heat the interior of the vehicle using the waste heat generated from the first electrical component 13. When temperature difference between the first electrical component 13 and the second electrical component 15 is minimal (i.e., not great), the controller 100 may determine the mode of the thermal management system of the vehicle as the second heating mode to heat the interior of the vehicle using the waste heat generated from the first electrical component 13 and the second electrical component 15. When the temperature of the first electrical component 13 is too high, the controller 100 may determine the mode of the thermal management system of the vehicle as the third heating mode and may cool the first electrical component 13 separately.

As shown in FIG. 3, in the first heating mode, the controller 100 opens the first valve V1, closes the three ports (i.e., plurality of ports) of the second valve V2 and the third valve V3, operates the first pump 12, and does not operate the second pump 14 or the third pump 23.

For example, the first coolant connection line 31 may communicate with the first coolant line 11 downstream of the first electrical component 13. Further, the connection of the second coolant connection line 41 with the first coolant line 11 and the connection of the third coolant connection line 51 with the second coolant line 21 may be blocked.

The coolant (i.e., whose temperature has risen while passing through the first electrical component 13) may flow into the heat exchanger 32 through the first coolant connection line 31. Air introduced from the outside into the HVAC module 60 through the fan 80 is heated through heat exchange with the coolant (i.e., whose temperature has risen in the heat exchanger 32) to heat the interior of the vehicle.

Therefore, in the first heating mode, the interior of the vehicle may be heated using only the waste heat generated from the first electrical component 13.

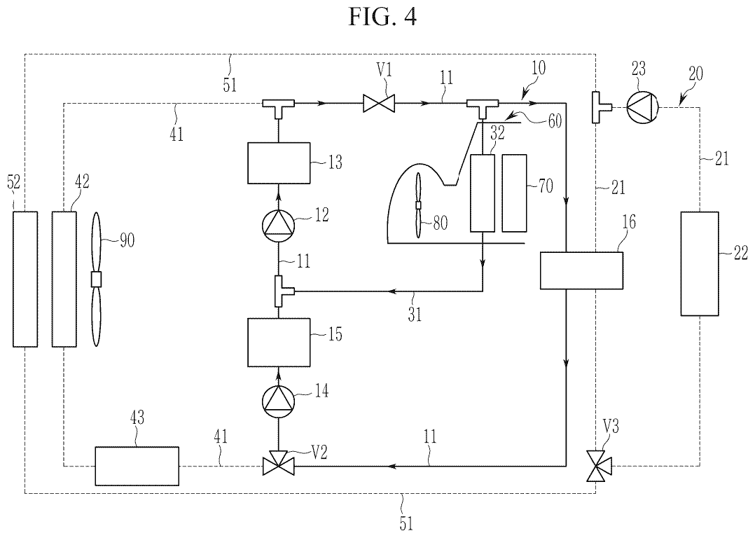

As shown in FIG. 4, in the second heating mode, the controller 100 may open the first valve V1, close the first port of the second valve V2 and open the second port and the third port of the second valve V2, close the three ports (i.e., plurality of ports) of the third valve V3, operate the first pump 12 and the second pump 14, and not operate the third pump 23.

For example, the first coolant connection line 31 may communicate with the first coolant line 11 downstream of the first electrical component 13. Further, the connection of the second coolant connection line 41 with the first coolant line 11 and the connection of the third coolant connection line 51 with the second coolant line 21 may be blocked.

In an embodiment, a portion of the coolant (i.e., whose temperature has risen while passing through the first electrical component 13 and/or the second electrical component 15, or whose temperature has risen while passing through one or more of the first electrical component 13 and the second electrical component 15) may flow into the heat exchanger 32 through the first coolant connection line 31. Air introduced from the outside into the HVAC module 60 through the fan 80 is heated through heat exchange with the coolant (i.e., whose temperature has risen in the heat exchanger 32), thereby heating the interior of the vehicle. The coolant discharged from the heat exchanger 32 may flow into the first coolant line 11 upstream of the first electrical component 13 through the first coolant connection line 31.

In an embodiment, a remaining portion of the coolant (i.e., whose temperature has risen when flowing past the first electrical component 13 and/or the second electrical component 15, or whose temperature has risen while passing the one or more of the first electrical component 13 and the second electrical component 15) may flow into the coolant mixing tank 16 through the first coolant line 11 arranged in parallel with the first coolant connection line 31. The coolant discharged from the coolant mixing tank 16 may flow into the first coolant line 11 upstream of the second electrical component 15 through the third port and the second port of the second valve V2.

In addition, in the above process, the controller 100 may control the rotational speed of the first pump 12 and the second pump 14 according to the temperatures of the first electrical component 13 and the second electrical component 15. For example, the higher the temperatures of the first electrical component 13 and the second electrical component 15, the higher the proportion of the coolant flowing into the coolant mixing tank 16.

Therefore, in the second heating mode, the interior of the vehicle may be heated using the waste heat generated from the first electrical component 13 and the second electrical component 15.

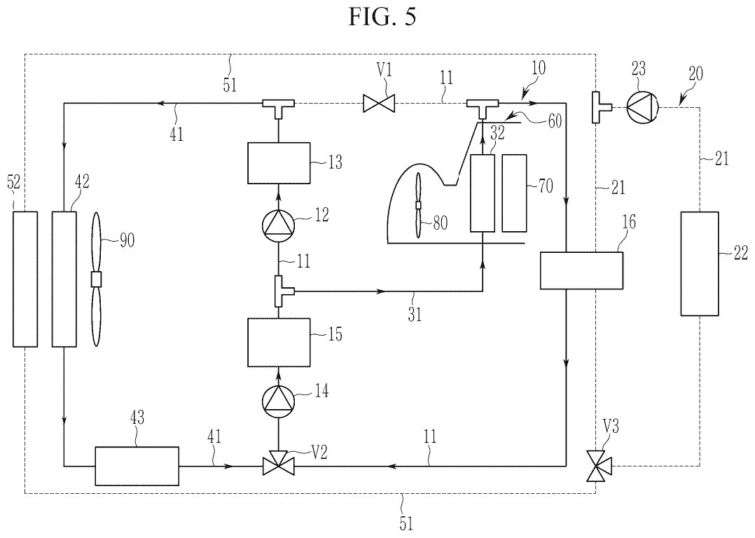

As shown in FIG. 5, in the third heating mode, the controller 100 may close the first valve V1, open the three ports (i.e., plurality of ports) of the second valve V2, close the three ports (i.e., plurality of ports) of the third valve V3, operate the first pump 12 and the second pump 14, and not operate the third pump 23.

For example, the connection of the first coolant connection line 31 with the first coolant line 11 downstream of the first electrical component 13 may be blocked. Further, the second coolant connection line 41 may communicate with the first coolant line 11 upstream of the second electrical component 15 through the second valve V2. Additionally, the connection of the third coolant connection line 51 with the second coolant line 21 may be blocked.

In an embodiment, a portion of the coolant (i.e., whose temperature has risen while passing through the second electrical component 15) may flow into the heat exchanger 32 through the first coolant connection line 31. Air introduced from the outside into the HVAC module 60 through the fan 80 is heated through heat exchange with the coolant (i.e., whose temperature has risen in the heat exchanger 32), thereby heating the interior of the vehicle.

The coolant discharged from the heat exchanger 32 may flow into the coolant mixing tank 16 through the first coolant line 11. The coolant discharged from the coolant mixing tank 16 may flow into the first coolant line 11 upstream of the second electrical component 15 through the third port and the second port of the second valve V2.

In an embodiment, the remaining portion of the coolant (i.e., whose temperature has risen while passing through the second electrical component 15) may flow into the first electrical component 13. The coolant (i.e., whose temperature has further risen while passing through the first electrical component 13) may flow into the second coolant connection line 41 connected through the second valve V2. The coolant that has flowed into the second coolant connection line 41 is cooled through heat exchange with external air in the first radiator 42, and the cooled coolant flows into the first coolant line 11 upstream of the second electrical component 15 through the first port and the second port of the second valve V2, thereby cooling the first electrical component 13 and the second electrical component 15.

For example, the controller 100 may control the rotational speed of the first pump 12 and the second pump 14 according to the temperatures of the first electrical component 13 and the second electrical component 15. Therefore, the higher the temperatures of the first electrical component 13 and the second electrical component 15, the higher the proportion of the coolant flowing into the first radiator 42.

Therefore, in the third heating mode, the interior of the vehicle is heated using the waste heat generated from the second electrical component 15, and the first electrical component 13 is cooled separately.

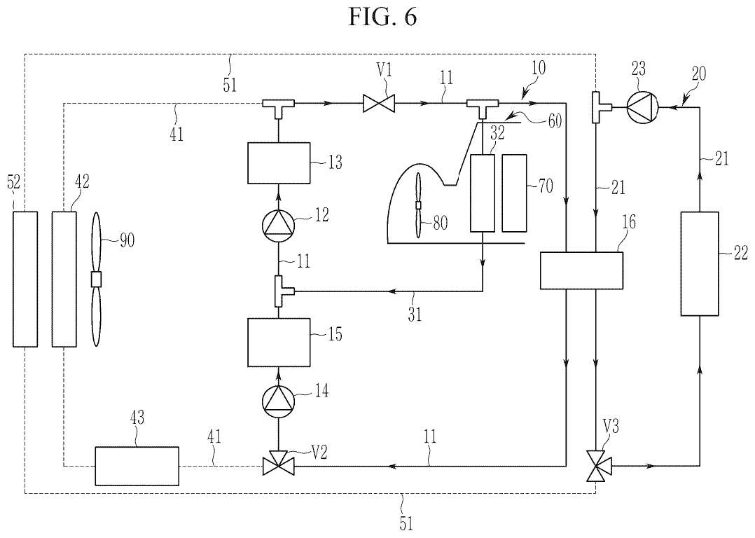

FIG. 6 to FIG. 8 illustrate a fourth heating mode to a sixth heating mode of the thermal management system of the vehicle. Specifically, when the vehicle travels in a low-temperature environment, if the interior of the vehicle and the battery 22 need to be heated, the controller 100 may determine the mode of the thermal management system of the vehicle as one of a fourth heating mode, a fifth heating mode, and a sixth heating mode (i.e., a fourth heating mode, a fifth heating mode, or a sixth heating mode). The controller 100 may determine the mode according to the temperature of the first electrical component 13, the temperature of the second electrical component 15, and the temperature of the battery 22.

In an embodiment, when the waste heat generated from the first electrical component 13 and the second electrical component 15 is less than or equal to the amount of heat required for heating the interior of the vehicle and the battery 22, the controller 100 may determine the mode of the thermal management system of the vehicle as the fourth heating mode. In the fourth heating mode, the interior of the vehicle and the battery 22 are heated using the waste heat generated from the first electrical component 13 and the second electrical component 15. When the waste heat generated from the first electrical component 13 and the second electrical component 15 is greater than the amount of heat required for heating the interior of the vehicle and the battery 22, the controller 100 may determine the mode of the thermal management system of the vehicle as the fifth heating mode. In the fifth heating mode, the interior of the vehicle and the battery 22 are heated using the waste heat generated from the first electrical component 13 and the second electrical component 15, and the battery 22 is cooled using the second radiator 52 to maintain the temperature of the battery 22. When the waste heat generated from the first electrical component 13 and the second electrical component 15 is much greater than the amount of heat required for heating the interior of the vehicle and the battery 22, the controller 100 may determine the mode of the thermal management system of the vehicle as the sixth heating mode. In the sixth heating mode, the interior of the vehicle and the battery 22 are heated using the waste heat generated from the second electrical component 15, and the first electrical component 13 and the second electrical component 15 are cooled using the first radiator 42.

As shown in FIG. 6, in the fourth heating mode, the controller 100 opens the first valve V1, closes the first port of the second valve V2 and opens the second port and the third port of the second valve V2, closes the first port of the third valve V3 and opens the second port and the third port of the third valve V3, and operates the first pump 12, the second pump 14, and the third pump 23.

For example, the first coolant connection line 31 may communicate with the first coolant line 11 downstream of the first electrical component 13. Further, the connection of the second coolant connection line 41 with the first coolant line 11 and the connection of the third coolant connection line 51 with the second coolant line 21 may be blocked.

In an embodiment, a portion of the coolant (i.e., whose temperature has risen while passing through the first electrical component 13 and/or the second electrical component 15, or whose temperature has risen while passing through one or more of the first electrical component 13 and the second electrical component 15) may flow into the heat exchanger 32 through the first coolant connection line 31. Air introduced from the outside into the HVAC module 60 through the fan 80 is heated through heat exchange with the coolant (i.e., whose temperature has risen in the heat exchanger 32), thereby heating the interior of the vehicle. The coolant discharged from the heat exchanger 32 may flow into the first coolant line 11 upstream of the first electrical component 13 through the first coolant connection line 31.

In an embodiment, a remaining portion of the coolant (i.e., whose temperature has risen while passing through the first electrical component 13 and/or the second electrical component 15, or whose temperature has risen while passing through the one or more of the first electrical component 13 and the second electrical component 15) may flow into the coolant mixing tank 16 through the first coolant line 11 arranged in parallel with the first coolant connection line 31. The coolant flowing past the battery 22 (i.e., whose temperature has risen while passing through the battery 22) may flow into the coolant mixing tank 16 through the second coolant line 21. The coolant that has flowed into the coolant mixing tank 16 through the first coolant line 11 (i.e., whose temperature has risen while passing through the first electrical component 13 and/or the second electrical component 15) and the coolant that has flowed into the coolant mixing tank 16 through the second coolant line 21 (i.e., whose temperature has risen while passing through the battery 22) are sufficiently mixed in the coolant mixing tank 16. In other words, both coolants (i.e., through the first coolant line 11 and through the second coolant line 21) are mixed in the coolant mixing tank 16. The temperature of the coolant in the first coolant line 11 before flowing into the coolant mixing tank 16 is higher than the temperature of the coolant in the second coolant line 21 before flowing into the coolant mixing tank 16. After the coolants of different temperatures (i.e., from the first coolant line 11 and from the second coolant line 21) are sufficiently mixed in the coolant mixing tank 16, a temperature of the coolant that has flowed from the coolant mixing tank 16 into the first coolant line 11 and a temperature of the coolant that has flowed from the coolant mixing tank 16 into the second coolant line 21 are the same. In other words, after sufficient mixing in the coolant mixing tank 16, both coolants (i.e., in the coolant mixing tank 16) have the same temperature and flow into their respective coolant lines (i.e., into the first coolant line 11 and into the second coolant line 21). The coolant that has flowed from the coolant mixing tank 16 into the first coolant line 11 may flow into the first coolant line 11 upstream of the second electrical component 15 through the third port and the second port of the second valve V2. The coolant that has flowed from the coolant mixing tank 16 into the second coolant line 21 may flow into the second coolant line 21 upstream of the battery 22 through the third port and the second port of the third valve V3. Therefore, the waste heat generated from the first electrical component 13 and the second electrical component 15 is transferred to the battery 22 through the coolant mixing tank 16 to heat the battery 22.

In addition, in the above process, the controller 100 may control the rotational speed of the first pump 12 and the second pump 14 according to the temperatures of the first electrical component 13 and the second electrical component 15. Therefore, the higher the temperatures of the first electrical component 13 and the second electrical component 15, the higher the proportion of the coolant flowing into the coolant mixing tank 16.

Therefore, in the fourth heating mode, the interior of the vehicle and the battery 22 may be heated using the waste heat generated from the first electrical component 13 and the second electrical component 15.

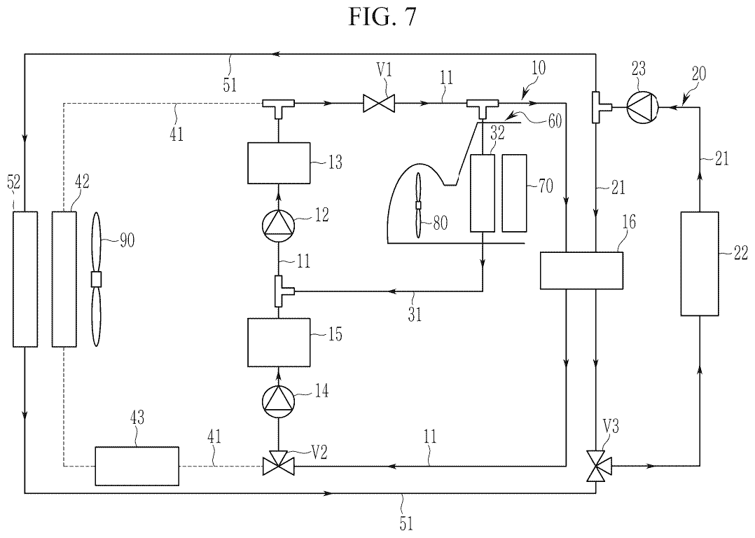

As shown in FIG. 7, in the fifth heating mode, the controller 100 may open the first valve V1, close the first port of the second valve V2 and open the second port and the third port of the second valve V2, open the three ports (i.e., plurality of ports) of the third valve V3, and operate the first pump 12, the second pump 14, and the third pump 23.

For example, the first coolant connection line 31 may communicate with the first coolant line 11 downstream of the first electrical component 13. Further, the connection of the second coolant connection line 41 with the first coolant line 11 may be blocked. Additionally, the third coolant connection line 51 may communicate with the second coolant line 21 through the third valve V3.

In an embodiment, a portion of the coolant (i.e., whose temperature has risen while passing through the first electrical component 13 and/or the second electrical component 15, or whose temperature has risen while passing through one or more of the first electrical component 13 and the second electrical component 15) may flow into the heat exchanger 32 through the first coolant connection line 31. Air introduced from the outside into the HVAC module 60 through the fan 80 is heated through heat exchange with the coolant (i.e., whose temperature has risen in the heat exchanger 32), thereby heating the interior of the vehicle.

In an embodiment, the remaining portion of the coolant (i.e., whose temperature has risen while passing through the first electrical component 13 and/or the second electrical component 15, or whose temperature has risen while passing through the one or more of the first electrical component 13 and the second electrical component 15) may flow into the coolant mixing tank 16 through the first coolant line 11 arranged in parallel with the first coolant connection line 31. A portion of the coolant that has passed through the battery 22 (i.e., whose temperature has risen while passing through the battery 22) may flow into the coolant mixing tank 16 through the second coolant line 21. The coolant that has flowed into the coolant mixing tank 16 through the first coolant line 11 (i.e., whose temperature has risen while passing through the first electrical component and/or the second electrical component 15) and the coolant that has flowed into the coolant mixing tank 16 through the second coolant line 21 (i.e., whose temperature has risen while passing through the battery 22) are sufficiently mixed in the coolant mixing tank 16. In other words, both coolants (i.e., through the first coolant line 11 and through the second coolant line 21) are mixed in the coolant mixing tank 16. The temperature of the coolant in the first coolant line 11 before flowing into the coolant mixing tank 16 is higher than the temperature of the coolant in the second coolant line 21 before flowing into the coolant mixing tank 16, and the coolants of different temperatures (i.e., from the first coolant line 11 and from the second coolant line 21) are sufficiently mixed in the coolant mixing tank 16. After sufficient mixing, the temperature of the coolant that has flowed from the coolant mixing tank 16 into the first coolant line 11 and the temperature of the coolant that has flowed from the coolant mixing tank 16 into the second coolant line 21 are the same. In other words, after sufficient mixing in the coolant mixing tank 16, both coolants (i.e., in the coolant mixing tank 16) have the same temperature and flow into their respective coolant lines (i.e., into the first coolant line 11 and into the second coolant line 21). The coolant that has flowed from the coolant mixing tank 16 into the first coolant line 11 may flow into the first coolant line 11 upstream of the second electrical component 15 through the third port and the second port of the second valve V2. The coolant that has flowed from the coolant mixing tank 16 into the second coolant line 21 may flow into the second coolant line 21 upstream of the battery 22 through the third port and the second port of the third valve V3. Therefore, the waste heat generated from the first electrical component 13 and the second electrical component 15 is transferred to the battery 22 through the coolant mixing tank 16 to heat the battery 22.

A remaining portion of the coolant passing through the battery 22 may flow into the third coolant connection line 51 connected through the third valve V3. The coolant that has flowed into the third coolant connection line 51 is cooled through heat exchange with external air in the second radiator 52, and the cooled coolant flows into the second coolant line 21 upstream of the battery 22 through the first port and the second port of the third valve V3, thereby cooling the battery 22.

In other words, the battery 22 is heated using the waste heat generated from the first electrical component 13 and the second electrical component 15, and the battery 22 is cooled using the second radiator 52 to maintain the temperature of the battery 22.

In addition, in this process, the controller 100 may control the rotational speed of the first pump 12 and the second pump 14 according to the temperatures of the first electrical component 13 and the second electrical component 15. Therefore, the higher the temperatures of the first electrical component 13 and the second electrical component 15, the higher the proportion of the coolant flowing into the coolant mixing tank 16. The controller 100 may control the flow rate of the third valve V3 according to the temperature of the battery 22. Therefore, the higher the temperature of the battery 22, the higher the proportion of the coolant flowing into the second radiator 52.

Therefore, in the fifth heating mode, the interior of the vehicle and the battery 22 may be heated using the waste heat generated from the first electrical component 13 and the second electrical component 15, and the temperature of the battery 22 may be maintained by cooling the battery 22 using the second radiator 52.

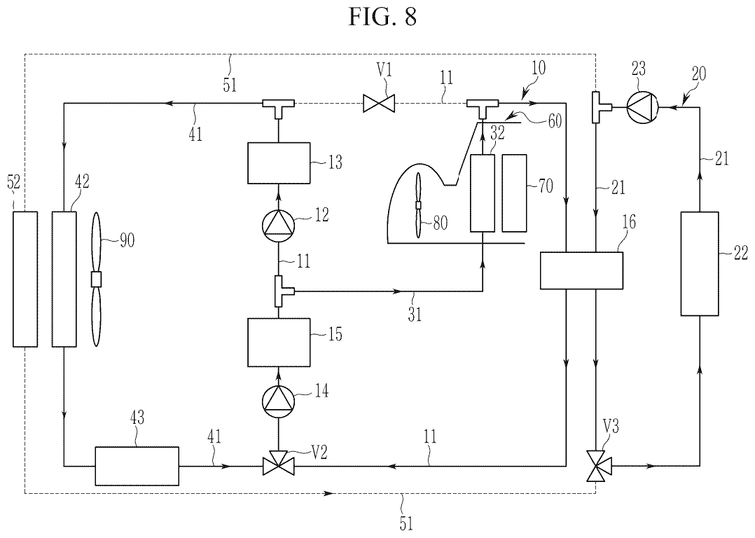

As shown in FIG. 8, in the sixth heating mode, the controller 100 may close the first valve V1, open the three ports (i.e., plurality of ports) of the second valve V2, close the first port of the third valve V3, open the second port and the third port of the third valve V2, and operate the first pump 12, the second pump 14, and the third pump 23.

For example, the connection of the first coolant connection line 31 with the first coolant line 11 downstream of the first electrical component 13 may be blocked. Further, the second coolant connection line 41 may communicate with the first coolant line 11 upstream of the second electrical component 15 through the second valve V2. Additionally, the connection of the third coolant connection line 51 with the second coolant line 21 may be blocked.

In an embodiment, a portion of the coolant (i.e., whose temperature has risen when flowing past the second electrical component 15) may flow into the heat exchanger 32 through the first coolant connection line 31. Air introduced from the outside into the HVAC module 60 through the fan 80 is heated through heat exchange with the coolant (i.e., whose temperature has risen in the heat exchanger 32), thereby heating the interior of the vehicle.

The coolant discharged from the heat exchanger 32 may flow into the coolant mixing tank 16 through the first coolant line 11. The coolant flowing past the battery 22 (i.e., whose temperature has risen while passing through the battery 22) may flow into the coolant mixing tank 16 through the second coolant line 21. The coolant that has flowed into the coolant mixing tank 16 through the first coolant line 11 (i.e., whose temperature has risen while passing through the second electrical component 15) and the coolant that has flowed into the coolant mixing tank 16 through the second coolant line 21 (i.e., whose temperature has risen while passing through the battery 22) are sufficiently mixed in the coolant mixing tank 16. In other words, after flowing into the coolant mixing tank 16, both coolants (i.e., from the first coolant line 11 and from the second coolant line 21) are mixed in the coolant mixing tank 16. The temperature of the coolant in the first coolant line 11 before flowing into the coolant mixing tank 16 is higher than the temperature of the coolant in the second coolant line 21 before flowing into the coolant mixing tank 16, and the coolants of different temperatures (i.e., from the first coolant line 11 and from the second coolant line 21) are sufficiently mixed in the coolant mixing tank 16. After sufficient mixing, the temperature of the coolant that has flowed from the coolant mixing tank 16 into the first coolant line 11 and the temperature of the coolant that has flowed from the coolant mixing tank 16 into the second coolant line 21 are the same. In other words, after sufficient mixing in the coolant mixing tank 16, both coolants (i.e., in the coolant mixing tank 16) have the same temperature and flow into their respective coolant lines (i.e., into the first coolant line 11 and into the second coolant line 21). The coolant that has flowed from the coolant mixing tank 16 into the first coolant line 11 may flow into the first coolant line 11 upstream of the second electrical component 15 through the third port and the second port of the second valve V2. The coolant that has flowed from the coolant mixing tank 16 into the second coolant line 21 may flow into the second coolant line 21 upstream of the battery 22 through the third port and the second port of the third valve V3. Therefore, the waste heat generated from the second electrical component 15 is transferred to the battery 22 through the coolant mixing tank 16 to heat the battery 22.

In an embodiment, the remaining portion of the coolant (i.e., whose temperature has risen when flowing past the second electrical component) may flow into the first electrical component 13. The coolant (i.e., whose temperature has further risen when flowing past the first electrical component 13) may flow into the second coolant connection line 14 connected through the second valve V2. The coolant that has flowed into the second coolant connection line 41 is cooled through heat exchange with external air in the first radiator 42, and the cooled coolant flows into the first coolant line 11 upstream of the second electrical component 15 through the first port and the second port of the second valve V2, thereby cooling the first electrical component 13 and the second electrical component 15.

In addition, in this process, the controller 100 may control the rotational speed of the first pump 12 and the second pump 14 according to the temperatures of the first electrical component 13 and the second electrical component 15. Therefore, the higher the temperatures of the first electrical component 13 and the second electrical component 15, the higher the proportion of the coolant flowing into the first radiator 42.

Therefore, in the sixth heating mode, the interior of the vehicle and the battery 22 may be heated using the waste heat generated from the second electrical component 15, and the first electrical component 13 and the second electrical component 15 may be cooled using the first radiator 42.

When the battery 22 is being charged in a low-temperature environment, the interior of the vehicle may need to be heated, but heating of the battery 22 is not necessary. During the charging process of the battery 22, heat may be generated only from the second electrical component 15, and therefore the interior of the vehicle may be heated using the waste heat generated from the second electrical component 15.

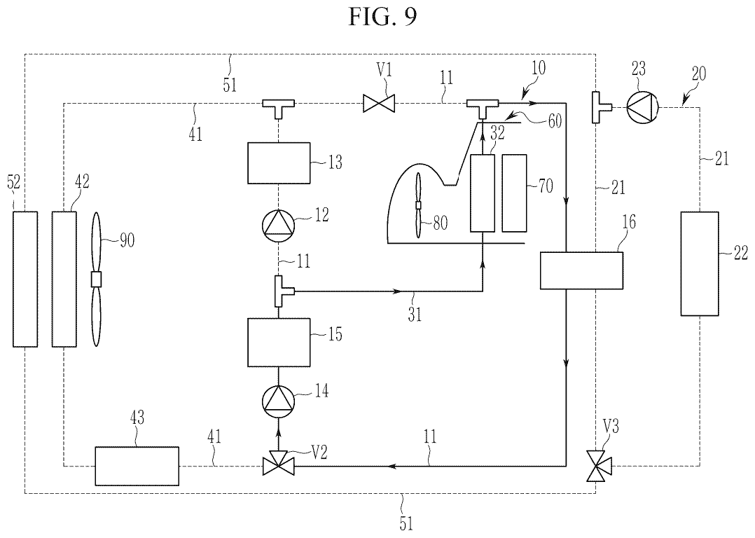

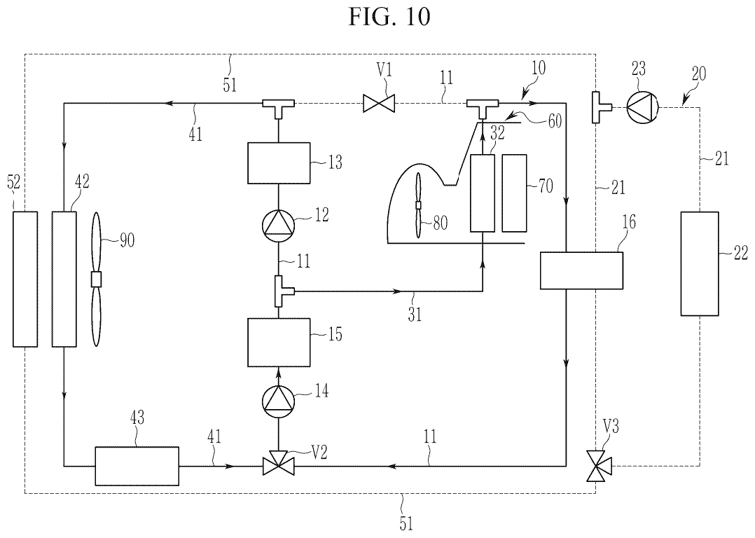

FIG. 9 and FIG. 10 illustrate a seventh heating mode and an eighth heating mode of the thermal management system of the vehicle. Specifically, when the battery 22 is being charged in a low-temperature environment, if the interior of the vehicle needs to be heated but the battery 22 does not need to be heated, the controller 100 may determine the mode of the thermal management system of the vehicle as one of the seventh heating mode and the eighth heating mode according to the temperature of the second electrical component 15.

In an embodiment, when the waste heat generated from the second electrical component 15 is less than or equal to the amount of heat required for heating the interior of the vehicle, the controller 100 may determine the mode of the thermal management system of the vehicle as the seventh heating mode. Therefore, the interior of the vehicle is heated using the waste heat generated from the second electrical component 15. When the waste heat generated from the second electrical component 15 is greater than the amount of heat required for heating the interior of the vehicle, the controller 100 may determine the mode of the thermal management system of the vehicle as the eighth heating mode. Therefore, the interior of the vehicle is heated using the waste heat generated from the second electrical component 15, and the second electrical component 15 is cooled using the first radiator 42.

As shown in FIG. 9, in the seventh heating mode, the controller 100 may close the first valve V1, close the first port of the second valve V2, open the second port and the third port of the second valve V2, close the three ports (i.e., plurality of ports) of the third valve V3, and operate the second pump 14.

For example, the connection of the first coolant connection line 31 with the first coolant line 11 downstream of the first electrical component 13, the connection of the second coolant connection line 41 with the first coolant line 11, and the connection of the third coolant connection line 51 with the second coolant line 21 may be blocked.

The coolant (i.e., whose temperature has risen while passing through the second electrical component 15) may flow into the heat exchanger 32 through the first coolant connection line 31. Air introduced from the outside into the HVAC module 60 through the fan 80 is heated through heat exchange with the coolant (i.e., whose temperature has risen in the heat exchanger 32), thereby heating the interior of the vehicle. The coolant discharged from the heat exchanger 32 may flow into the coolant mixing tank 16 through the first coolant line 11. The coolant discharged from the coolant mixing tank 16 may flow into the first coolant line 11 upstream of the second electrical component 15 through the third port and the second port of the second valve V2.

Therefore, in the seventh heating mode, the interior of the vehicle may be heated using the waste heat generated from the second electrical component 15.

As shown in FIG. 10, in the eighth heating mode, the controller 100 may close the first valve V1, open the three ports (i.e., plurality of ports) of the second valve V2, close the three ports (i.e., plurality of ports) of the third valve V3, and operate the first pump 12 and the second pump 14.

For example, the connection of the first coolant connection line 31 with the first coolant line 11 downstream of the first electrical component 13 may be blocked. Further, the second coolant connection line 41 may communicate with the first coolant line 11 through the second valve V2. Additionally, the connection of the third coolant connection line 51 with the second coolant line 21 may be blocked.

In an embodiment, a portion of the coolant (i.e., whose temperature has risen while passing through the second electrical component 15) may flow into the heat exchanger 32 through the first coolant connection line 31. Air introduced from the outside into the HVAC module 60 through the fan 80 is heated through heat exchange with the coolant (i.e., whose temperature has risen in the heat exchanger 32), thereby heating the interior of the vehicle. The coolant discharged from the heat exchanger 32 may flow into the coolant mixing tank 16 through the first coolant line 11. The coolant that has flowed from the coolant mixing tank 16 into the first coolant line 11 may flow into the first coolant line 11 upstream of the second electrical component 15 through the third port and the second port of the second valve V2.

In an embodiment, the remaining portion of the coolant (i.e., whose temperature has risen while passing through the second electrical component 15) may flow into the first electrical component 13. The coolant flowing past the first electrical component 13 may flow into the second coolant connection line 41 connected through the second valve V2. The coolant that has flowed into the second coolant connection line 41 is cooled through heat exchange with external air in the first radiator 42, and the cooled coolant flows into the first coolant line 11 upstream of the second electrical component 15 through the first port and the second port of the second valve V2, thereby cooling the second electrical component 15.

Therefore, in the eighth heating mode, the interior of the vehicle may be heated using the waste heat generated from the second electrical component 15, and at the same time, the second electrical component 15 may be cooled using the first radiator 42.

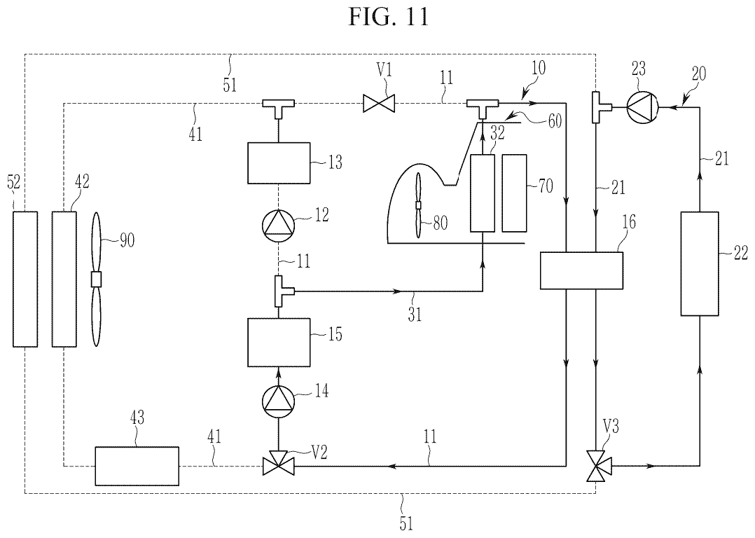

FIG. 11 illustrates a ninth heating mode of the thermal management system of the vehicle. Specifically, when the battery 22 is charged in a low-temperature environment, if the interior of the vehicle and the battery 22 need to be heated, the controller 100 may determine the mode of the thermal management system of the vehicle as the ninth heating mode.

As shown in FIG. 11, in the ninth heating mode, the controller 100 may close the first valve V1, close the first port of the second valve V2, open the second port and the third port of the second valve V2, close the first port of the third valve V3, open the second port and the third port of the third valve V2, and operate the second pump 14 and the third pump 23.

For example, the connection of the first coolant connection line 31 with the first coolant line 11 downstream of the first electrical component 13, the connection of the second coolant connection line 41 with the first coolant line 11, and the connection of the third coolant connection line 51 with the second coolant line 21 may be blocked.

The coolant (i.e., whose temperature has risen while passing through the second electrical component 15) may flow into the heat exchanger 32 through the first coolant connection line 31. Air introduced from the outside into the HVAC module 60 through the fan 80 is heated through heat exchange with the coolant (i.e., whose temperature has risen in the heat exchanger 32), thereby heating the interior of the vehicle.

The coolant discharged from the heat exchanger 32 may flow into the coolant mixing tank 16 through the first coolant line 11. The coolant that has passed through the battery 22 (i.e., whose temperature has risen while passing through the battery 22) may flow into the coolant mixing tank 16 through the second coolant line 21. The coolant that has flowed into the coolant mixing tank 16 through the first coolant line 11 (i.e., whose temperature has risen while passing through the second electrical component 15) and the coolant that has flowed into the coolant mixing tank 16 through the second coolant line 21 (i.e., whose temperature has risen while passing through the battery 22) are sufficiently mixed in the coolant mixing tank 16. In other words, both coolants (i.e., through the first coolant line 11 and through the second coolant line 21) are mixed in the coolant mixing tank 16. The temperature of the coolant in the first coolant line 11 before flowing into the coolant mixing tank 16 is higher than the temperature of the coolant in the second coolant line 21 before flowing into the coolant mixing tank 16, and the coolants of different temperatures (i.e., from the first coolant line 11 and from the second coolant line 21) are sufficiently mixed in the coolant mixing tank 16. After sufficient mixing, the temperature of the coolant that has flowed from the coolant mixing tank 16 into the first coolant line 11 and the temperature of the coolant that has flowed from the coolant mixing tank 16 into the second coolant line 21 are the same. In other words, after sufficient mixing in the coolant mixing tank 16, both coolants (i.e., in the coolant mixing tank 16) have the same temperature and flow into their respective coolant lines (i.e., into the first coolant line 11 and into the second coolant line 21). The coolant that has flowed from the coolant mixing tank 16 into the first coolant line 11 may flow into the first coolant line 11 upstream of the second electrical component 15 through the third port and the second port of the second valve V2. The coolant that has flowed from the coolant mixing tank 16 into the second coolant line 21 may flow into the second coolant line 21 upstream of the battery 22 through the third port and the second port of the third valve V3. Therefore, the waste heat generated from the second electrical component 15 is transferred to the battery 22 through the coolant mixing tank 16 to heat the battery 22.

Therefore, in the ninth heating mode, the interior of the vehicle and the battery 22 may be heated using the waste heat generated from the second electrical component 15.

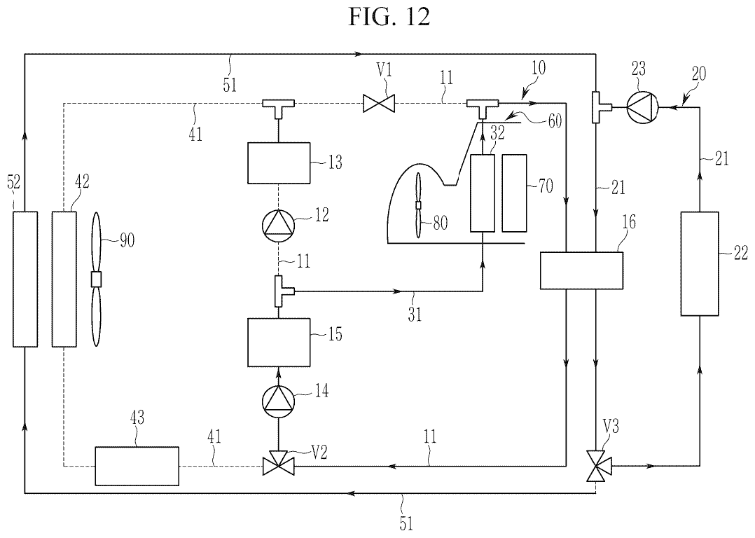

FIG. 12 illustrates a tenth heating mode of the thermal management system of the vehicle. Specifically, when the battery 22 is charged in a low-temperature environment, if the interior of the vehicle needs to be heated and the temperature of the battery 22 needs to be maintained, the controller 100 may determine the mode of the thermal management system of the vehicle as the tenth heating mode.

As shown in FIG. 12, in the tenth heating mode, the controller 100 may close the first valve V1, close the first port of the second valve V2, open the second port and the third port of the second valve V2, open the three ports (i.e., plurality of ports) of the third valve V3, and operate the second pump 14 and the third pump 23.

For example, the connection of the first coolant connection line 31 with the first coolant line 11 downstream of the first electrical component 13 and the connection of the second coolant connection line 41 with the first coolant line 11 may be blocked. Further, the third coolant connection line 51 may communicate with the second coolant line 21 through the third valve V3.

The coolant (i.e., whose temperature has risen while passing through the second electrical component 15) may flow into the heat exchanger 32 through the first coolant connection line 31. Air introduced from the outside into the HVAC module 60 through the fan 80 is heated through heat exchange with the coolant (i.e., whose temperature has risen in the heat exchanger 32), thereby heating the interior of the vehicle.

The coolant discharged from the heat exchanger 32 may flow into the coolant mixing tank 16 through the first coolant line 11. A portion of the coolant that has passed through the battery 22 (i.e., whose temperature has risen while passing through the battery 22) may flow into the coolant mixing tank 16 through the second coolant line 21. The coolant that has flowed into the coolant mixing tank 16 through the first coolant line 11 (i.e., whose temperature has risen while passing through the second electrical component 15) and the coolant that has flowed into the coolant mixing tank 16 through the second coolant line 21 (i.e., whose temperature has risen while passing through the battery 22) are sufficiently mixed in the coolant mixing tank 16. In other words, both coolants (i.e., through the first coolant line 11 and through the second coolant line 21) are mixed in the coolant mixing tank 16. The temperature of the coolant in the first coolant line 11 before flowing into the coolant mixing tank 16 is higher than the temperature of the coolant in the second coolant line 21 before flowing into the coolant mixing tank 16, and the coolants of different temperatures (i.e., from the first coolant line 11 and from the second coolant line 21) are sufficiently mixed in the coolant mixing tank 16. After sufficient mixing, the temperature of the coolant that has flowed from the coolant mixing tank 16 into the first coolant line 11 and the temperature of the coolant that has flowed from the coolant mixing tank 16 into the second coolant line 21 are the same. In other words, after sufficient mixing in the coolant mixing tank 16, both coolants (i.e., in the coolant mixing tank 16) have the same temperature and flow into their respective coolant lines (i.e., into the first coolant line 11 and into the second coolant line 21). The coolant that has flowed from the coolant mixing tank 16 into the first coolant line 11 may flow into the first coolant line 11 upstream of the second electrical component 15 through the third port and the second port of the second valve V2. The coolant that has flowed from the coolant mixing tank 16 into the second coolant line 21 may flow into the second coolant line 21 upstream of the battery 22 through the third port and the second port of the third valve V3. Therefore, the waste heat generated from the second electrical component 15 is transferred to the battery 22 through the coolant mixing tank 16 to heat the battery 22.

The remaining portion of the coolant flowing past the battery 22 may flow into the third coolant connection line 51 connected through the third valve V3. The coolant that has flowed into the third coolant connection line 51 is cooled through heat exchange with external air in the second radiator 52, and the cooled coolant flows into the second coolant line 21 upstream of the battery 22 through the first port and the second port of the third valve V3, thereby cooling the battery 22.

In other words, the battery 22 is heated using the waste heat generated from the second electrical component 15, and the temperature of the battery 22 is maintained by cooling the battery 22 using the second radiator 52.

In addition, in this process, the controller 100 may control the flow rate of the third valve V3 according to the temperature of the battery 22. Therefore, the higher the temperature of the battery 22, the higher the proportion of the coolant flowing into the second radiator 52.

Therefore, in the tenth heating mode, the interior of the vehicle and the battery 22 may be heated using the waste heat generated from the second electrical component 15, and the temperature of the battery 22 may be maintained by cooling the battery 22 using the second radiator 52.

When the vehicle travels in a high-temperature environment, cooling of the first electrical component 13 and the second electrical component 15 and/or cooling of the battery 22 may be necessary.

FIG. 13 illustrates a cooling mode of the thermal management system of the vehicle. Specifically, when the vehicle travels in a high-temperature environment, if cooling of the first electrical component 13 and the second electrical component 15 and/or cooling of the battery 22 is necessary, the controller 100 may determine the mode of the thermal management system of the vehicle as the cooling mode.

In an embodiment, if the first electrical component 13 and the second electrical component 15 need to be cooled and the battery 22 does not need to be cooled, the controller 100 may determine the cooling mode as the cooling mode used for the first electrical component 13 and the second electrical component 15. When cooling of the battery 22 is necessary and cooling of the first electrical component 13 and the second electrical component 15 is not necessary, the controller 100 may determine the cooling mode as the cooling mode used for the battery 22. When the first electrical component 13, the second electrical component 15, and the battery 22 all need to be cooled, the controller 100 may execute (i.e., simultaneously) the cooling mode used for the first electrical component 13 and the second electrical component 15 and the cooling mode used for the battery 22.

FIG. 13 further illustrates an embodiment where the cooling mode used for the first electrical component 13 and the second electrical component 15 and the cooling mode used for the battery 22 are executed (i.e., simultaneously).

As shown in FIG. 13, in the cooling mode, the controller 100 may close the first valve V1, close the third port of the second valve V2, open the first port and the second port of the second valve V2, close the third port of the third valve V3 and open the first port and the second port of the third valve V3, and operate the first pump 12, the second pump 14, and the third pump 23.

For example, the connection of the first coolant connection line 31 with the first coolant line 11 downstream of the first electrical component 13 may be blocked. Further, the second coolant connection line 41 may communicate with the first coolant line 11 through the second valve V2. Additionally, the third coolant connection line 51 may communicate with the second coolant line 21 through the third valve V3.

In an embodiment, the coolant (i.e., whose temperature has risen while passing through the first electrical component 13 and/or the second electrical component 15, or whose temperature has risen while passing through one or more of the first electrical component 13 and the second electrical component 15) may flow into the second coolant connection line 41 connected through the second valve V2. The coolant that has flowed into the second coolant connection line 41 is cooled through heat exchange with external air in the first radiator 42, and the cooled coolant flows into the first coolant line 11 upstream of the second electrical component 15 through the first port and the second port of the second valve V2, thereby cooling the first electrical component 13 and the second electrical component 15.

In an embodiment, the coolant (i.e., whose temperature has risen when flowing past the battery 22) may flow into the third coolant connection line 51 connected through the third valve V3. The coolant that has flowed into the third coolant connection line 51 is cooled through heat exchange with external air in the second radiator 52, and the cooled coolant flows into the second coolant line 21 upstream of the battery 22 through the first port and the second port of the third valve V3, thereby cooling the battery 22.

Therefore, in the cooling mode, the first electrical component 13 and the second electrical component 15 may be cooled using the first radiator 42, and the battery 22 may be cooled using the second radiator 52.

Although FIG. 13 has been described as cooling (i.e., simultaneously) of the first electrical component 13, the second electrical component 15, and the battery 22, the present invention is not limited thereto. If necessary, only the first electrical component 13 and the second electrical component 15 may be cooled, or only the battery 22 may be cooled.

The thermal management system for a vehicle according to an embodiment of the present disclosure may heat the interior of the vehicle and the battery with waste heat generated from electrical components in the vehicle using a heat exchanger and a coolant mixing tank. Compared to a heat pump system, the thermal management system for a vehicle according to an embodiment of the present disclosure has a simple structure and low cost, and may reduce power consumption of the heater, thereby improving the driving range of an electric vehicle.

Although embodiments of the present disclosure have been described herein, it is understood that the present disclosure is not limited to the disclosed embodiments. On the contrary, the present disclosure is intended to cover various modifications and equivalent arrangements included within the spirit and scope of the appended claims.

What is claimed is:

1. A thermal management system for a vehicle, comprising:
a first coolant circulation circuit including a first pump, a first electrical component, a second pump, and a second electrical component that are connected through a first coolant line;
a first coolant connection line including a first end and a second end, wherein the first end of the first coolant connection line is connected to the first coolant line at a position upstream of the first pump and the first electrical component, and downstream of the second pump and the second electrical component, and the second end of the first coolant connection line is connected to the first coolant line at a position downstream of the first pump and the first electrical component, and upstream of the second pump and the second electrical component;
a heating ventilation and air conditioning (HVAC) module of an air conditioning device disposed on the first coolant connection line; and
a heat exchanger disposed on the first coolant connection line and located inside the HVAC module, the heat exchanger being configured to heat air introduced into the HVAC module using a coolant whose temperature has risen while passing through at least one of the first electrical component or the second electrical component.

2. The thermal management system of claim 1, further comprising:
a second coolant connection line including a first end and a second end, wherein the first end of the second coolant connection line is connected to the first coolant line at a position downstream of the first electrical component, and the second end of the second coolant connection line is connected to the first coolant line at a position upstream of the second electrical component; and
a first radiator disposed on the second coolant connection line and configured to cool the coolant whose temperature has risen while passing through the first electrical component and the second electrical component.

3. The thermal management system of claim 2, further comprising:
a second coolant circulation circuit including a battery and a third pump connected through a second coolant line; and
a coolant mixing tank disposed on the first coolant line and the second coolant line and configured to mix the coolant in the first coolant line and the coolant in the second coolant line.

4. The thermal management system of claim 3, further comprising:
a third coolant connection line including a first end and a second end, wherein the first end of the third coolant connection line is connected to the second coolant line at a position upstream of the battery, and the second end of the third coolant connection line is connected to the second coolant line at a position downstream of the battery; and
a second radiator disposed on the third coolant connection line and configured to cool the coolant whose temperature has risen while passing through the battery.

5. The thermal management system of claim 4, further comprising:
a first valve configured as a switch valve and disposed on the first coolant line downstream of the first electrical component;
a second valve configured as a three-way valve and disposed on the first coolant line upstream of the second electrical component, wherein the second valve comprises a plurality of ports including a first port, a second port, and a third port; and
a third valve configured as a three-way valve and disposed on the second coolant line, wherein the third valve comprises a plurality of ports including a first port, a second port, and a third port,
wherein the second end of the second coolant connection line is selectively connected to the first coolant line through the second valve, and the first end of the third coolant connection line is selectively connected to the second coolant line through the third valve,
the first port of the second valve is connected to the second coolant connection line, the second port of the second valve is connected to the first coolant line upstream of the second electrical component, and the third port of the second valve is connected to the first coolant line downstream of the coolant mixing tank, and
the first port of the third valve is connected to the third coolant connection line, the second port of the third valve is connected to the second coolant line upstream of the battery, and the third port of the third valve is connected to the second coolant line downstream of the coolant mixing tank.

6. The thermal management system of claim 5, further comprising a controller electrically connected to the first valve, the second valve, the third valve, the first pump, the second pump, and the third pump,
wherein the controller is configured to:
determine a mode of the thermal management system according to one or more of a temperature of the first electrical component, a temperature of the second electrical component, and a temperature of the battery; and
control operation of the first valve, the second valve, and the third valve and operation of the first pump, the second pump, and the third pump according to the mode.

7. The thermal management system of claim 6, wherein:
when a vehicle interior needs to be heated and the battery does not need to be heated in a vehicle driving state, the controller is configured to determine the mode of the thermal management system as a first heating mode, a second heating mode, or a third heating mode according to the temperature of the first electrical component and the temperature of the second electrical component.

8. The thermal management system of claim 7, wherein:
in the first heating mode, the controller is configured to: open the first valve, close the plurality of ports of the second valve and the plurality of ports of the third valve, and operate the first pump, and
the coolant whose temperature has risen while passing through the first electrical component flows into the heat exchanger through the first coolant connection line to heat the air introduced into the HVAC module.

9. The thermal management system of claim 7, wherein:
in the second heating mode, the controller is configured to: open the first valve, close the first port of the second valve, open the second port of the second valve and the third port of the second valve, close the plurality of ports of the third valve, and operate the first pump and the second pump, and
the coolant whose temperature has risen while passing through the first electrical component and the second electrical component flows into the heat exchanger through the first coolant connection line to heat the air introduced into the HVAC module and passes through the coolant mixing tank through the first coolant line to flow back into the second electrical component.

10. The thermal management system of claim 7, wherein:
in the third heating mode, the controller is configured to: close the first valve, open the plurality of ports of the second valve, close the plurality of ports of the third valve, and operate the first pump and the second pump,
a portion of the coolant whose temperature has risen while passing through the second electrical component flows into the heat exchanger through the first coolant connection line to heat the air introduced into the HVAC module,
a remainder of the coolant whose temperature has risen while passing through the second electrical component and the coolant whose temperature has risen while passing through the first electrical component flow into the first radiator disposed on the second coolant connection line connected through the second valve and are cooled, and
the coolant cooled by the first radiator flows back into the second electrical component through the first coolant line to cool the one or more of the first electrical component and the second electrical component.

11. The thermal management system of claim 6, wherein:
when the vehicle interior and the battery need to be heated in a vehicle driving state, the controller is configured to determine the mode of the thermal management system as a fourth heating mode, a fifth heating mode, or a sixth heating mode according to the temperature of the first electrical component, the temperature of the second electrical component, and the temperature of the battery.

12. The thermal management system of claim 11, wherein:
in the fourth heating mode, the controller is configured to: open the first valve, close the first port of the second valve, open the second port of the second valve and the third port of the second valve, close the first port of the third valve, open the second port of the third valve and the third port of the third valve, and operate the first pump, the second pump, and the third pump,
a portion of the coolant whose temperature has risen while passing through the first electrical component and the second electrical component flows into the heat exchanger through the first coolant connection line to heat the air introduced into the HVAC module, and
a remainder of the coolant whose temperature has risen while passing through the first electrical component and the second electrical component flows into the coolant mixing tank through the first coolant line and is mixed with the coolant whose temperature has risen while passing through the battery that has flowed into the coolant mixing tank through the second coolant line, and raises the temperature of the coolant circulating in the second coolant line to heat the battery.

13. The thermal management system of claim 11, wherein:
in the fifth heating mode, the controller is configured to: open the first valve, close the first port of the second valve, open the second port of the second valve and the third port of the second valve, open the plurality of ports of the third valve, and operate the first pump, the second pump, and the third pump,
a portion of the coolant whose temperature has risen while passing through the first electrical component and the second electrical component flows into the heat exchanger through the first coolant connection line to heat the air introduced into the HVAC module,
a remainder of the coolant whose temperature has risen while passing through the first electrical component and the second electrical component flows into the coolant mixing tank through the first coolant line, and a portion of the coolant whose temperature has risen while passing through the battery flows into the coolant mixing tank through the second coolant line,
the coolant in the first coolant line and the coolant in the second coolant line is mixed in the coolant mixing tank to raise the temperature of the coolant in the second coolant line,
a remainder of the coolant whose temperature has risen while passing through the battery flows into the second radiator through the third coolant connection line connected through the third valve and is cooled, and
the coolant cooled in the second radiator lowers the temperature of the coolant in the second coolant line to maintain the temperature of the battery.

14. The thermal management system of claim 11, wherein:
in the sixth heating mode, the controller is configured to: close the first valve, open the plurality of ports of the second valve, close the first port of the third valve, open the second port of the third valve and the third port of the third valve, and operate the first pump, the second pump, and the third pump,
a portion of the coolant whose temperature has risen while passing through the second electrical component flows into the heat exchanger through the first coolant connection line to heat the air introduced into the HVAC module,
the portion of the coolant whose temperature has risen while passing through the second electrical component that has passed through the heat exchanger flows into the coolant mixing tank through the first coolant line, the coolant whose temperature has risen while passing through the battery flows into the coolant mixing tank through the second coolant line,
the coolant in the first coolant line and the coolant in the second coolant line is mixed in the coolant mixing tank to raise the temperature of the coolant in the second coolant line, and the coolant in the second coolant line whose temperature has risen heats the battery,
a remainder of the coolant whose temperature has risen while passing through the second electrical component and the coolant whose temperature has risen while passing through the first electrical component flow into the first radiator disposed on the second coolant connection line connected through the second valve and are cooled, and
the coolant cooled by the first radiator flows back into the second electrical component through the first coolant line to cool the one or more of the first electrical component and the second electrical component.

15. The thermal management system of claim 6, wherein:
when the vehicle interior needs to be heated and the battery does not need to be heated in a battery charging state, the controller is configured to determine the mode of the thermal management system for the vehicle as a seventh heating mode or an eighth heating mode according to the temperature of the second electrical component.

16. The thermal management system of claim 15, wherein:
in the seventh heating mode, the controller is configured to: close the first valve, close the first port of the second valve, open the second port of the second valve and the third port of the second valve, close the plurality of ports of the third valve, and operate the second pump, and
the coolant whose temperature has risen while passing through the second electrical component flows into the heat exchanger through the first coolant connection line to heat the air introduced into the HVAC module.

17. The thermal management system of claim 15, wherein:
in the eighth heating mode, the controller is configured to: close the first valve, open the plurality of ports of the second valve, close the plurality of ports of the third valve, and operate the first pump and the second pump,
a portion of the coolant whose temperature has risen while passing through the second electrical component flows into the heat exchanger through the first coolant connection line to heat the air introduced into the HVAC module,
a remainder of the coolant whose temperature has risen while passing through the second electrical component flows into the first radiator through the second coolant connection line connected through the second valve and is cooled, and
the coolant cooled by the first radiator flows back into the second electrical component to cool the second electrical component.

18. The thermal management system of claim 6, wherein:
when the vehicle interior and the battery need to be heated in a battery charging state, the controller is configured to determine the mode of the thermal management system for the vehicle as a ninth heating mode, and
in the ninth heating mode, the controller is configured to: close the first valve, close the first port of the second valve, open the second port of the second valve and the third port of the second valve, close the first port of the third valve, open the second port of the third valve and the third port of the third valve, and operate the second pump and the third pump,
the coolant whose temperature has risen while passing through the second electrical component flows into the heat exchanger through the first coolant connection line to heat the air introduced into the HVAC module,
the coolant whose temperature has risen while passing through the second electrical component that has passed through the heat exchanger flows into the coolant mixing tank through the first coolant line and the coolant whose temperature has risen while passing through the battery flows into the coolant mixing tank through the second coolant line,
the coolant in the first coolant line and the coolant in the second coolant line is mixed in the coolant mixing tank to raise the temperature of the coolant in the second coolant line, and
the coolant in the second coolant line whose temperature has risen heats the battery.

19. The thermal management system of claim 6, wherein:
when the vehicle interior needs to be heated and the temperature of the battery needs to be maintained in a battery charging state, the controller is configured to determine the mode of the thermal management system for the vehicle as a tenth heating mode, and
in the tenth heating mode, the controller is configured to: close the first valve, close the first port of the second valve, open the second port of the second valve and the third port of the second valve, open the plurality of ports of the third valve, and operate the second pump and the third pump,
the coolant whose temperature has risen while passing through the second electrical component flows into the heat exchanger through the first coolant connection line to heat the air introduced into the HVAC module,
the coolant whose temperature has risen while passing through the second electrical component that has passed through the heat exchanger flows into the coolant mixing tank through the first coolant line and a portion of the coolant whose temperature has risen while passing through the battery flows into the coolant mixing tank through the second coolant line,
the coolant in the first coolant line and the coolant in the second coolant line is mixed in the coolant mixing tank to raise the temperature of the coolant in the second coolant line,
a remainder of the coolant whose temperature has risen while passing through the battery flows into the second radiator through the third coolant connection line connected through the third valve and is cooled, and
the coolant cooled in the second radiator lowers the temperature of the coolant in the second coolant line to maintain the temperature of the battery.

20. The thermal management system for a vehicle of claim 6, wherein:
when one or more of cooling of the first electrical component and the second electrical component and cooling of the battery is required in a vehicle driving state, the controller is configured to determine the mode of the thermal management system for the vehicle as a cooling mode,
in the cooling mode used for the first electrical component and the second electrical component, the controller is configured to: close the third port of the second valve, open the first port of the second valve and the second port of the second valve, close the first valve, and operate the first pump and the second pump,
the coolant whose temperature has risen while passing through the first electrical component and the second electrical component flows into the first radiator through the second coolant connection line connected through the second valve and is cooled, and
the coolant cooled by the first radiator flows back into the second electrical component to cool the one or more of the first electrical component and the second electrical component, and
in the cooling mode used for the battery, the controller is configured to: close the third port of the third valve, open the first port of the third valve and the second port of the third valve, and operate the third pump,
the coolant whose temperature has risen while passing through the battery flows into the second radiator through the third coolant connection line connected through the third valve and is cooled, and
the coolant cooled by the second radiator flows into the second coolant line to cool the battery.
